(19) United States
(12) Patent Application Publication
(10) Pub. No.: US 2009/0071754 A1
(43) Pub. Date: Mar. 19, 2009

(54) Metering Lubrication oil at low flow rates

(76) Inventor: Malcolm J. McArthur, Fallbrook, CA (US)

Correspondence Address: STEPHEN GEORGE MICAN, Post Office Box 803338, #8973, Chicago, IL, 60680-3338, US

(21) Appl. No.: 11/901,408

(22) Filed: Sep. 17, 2007

(51) Int. Cl. F16N 27/00

(52) U.S. Cl. 184/7.4

(57) ABSTRACT

A lubrication system that transfers sequential defined quantities of lubrication oil to lubrication points comprises: a lubrication oil reservoir for storing the lubrication oil; at least one positive displacement metering capsule; and a transfer valve for each capsule that alternately transfers lubrication oil from the lubrication oil reservoir to its respective capsule and from its respective capsule to its respective lubrication points; wherein each capsule increases its volume to receive the lubrication oil when its respective transfer valve transfers lubrication oil from the lubrication oil reservoir and decreases its volume to discharge lubrication oil when its respective transfer valve transfers lubrication oil to its respective lubrication points.

### FIELD OF THE INVENTION

The invention relates to lubrication systems, and more particularly to lubrication systems that dispense low quantities of lubrication oil.

### BACKGROUND OF THE INVENTION

Gas turbine engines for short-life expendable applications commonly employ rolling element bearings to journal rotating engine parts. Adequate lubrication of such bearings is essential to meeting designed life and reliability requirements. Long-life non-expendable engines use recirculating oil lubrication systems to secure optimal bearing life. However, such recirculating oil systems are not suitable for expendable engines due to their complexity, weight and cost.

Expendable short-life engines also have design requirements that include maintenance-free long-term storage without servicing prior to use. One example of a lubrication system for expendable engines that does not incur the limitations of complexity, weight, cost, leakage and restricted storage conditions of recirculating oil lubrication systems is a so-called “constant loss” non-recirculating lubrication system. It comprises an oil reservoir and a simple delivery mechanism. The delivery mechanism supplies fresh oil to the bearings that flows through them and then through the engine flow path. There is no recirculation of the supplied oil so that lubrication only continues as long as the reservoir can deliver oil. The advantages of this system comprise its simplicity, size and weight.

Such a constant loss lubrication system requires accurate metering of lubrication flow to the bearings under a wide variety of operating conditions in order to maximize operating time with a limited quantity of lubrication oil in the reservoir. Such operating conditions may comprise temperatures ranging from minus 40 to plus 80 degrees C. and altitudes ranging from sea level to 10 kilometres. It is generally difficult to accurately dispense small quantities of oil in a true volumetric positive displacement manner with such a variation of temperatures and altitudes due to corresponding changes in lubrication oil viscosity, oil supply pressure and variation in atmospheric backpressure whilst retaining a small, lightweight and low cost lubrication system. Attempts to do so using piston pumps with inlet and outlet valves, peristaltic pumps, metering solenoid valves and so forth have met with mixed results.

### SUMMARY OF THE INVENTION

The invention generally comprises a lubrication system for transferring sequential defined quantities of lubrication oil to lubrication points, comprising: a lubrication oil reservoir for storing the lubrication oil; at least one positive displacement metering capsule; and a transfer valve for each capsule that alternately transfers lubrication oil from the lubrication oil reservoir to its respective capsule and from its respective capsule to its respective lubrication points; wherein each capsule increases its volume to receive the lubrication oil when its respective transfer valve transfers lubrication oil from the lubrication oil reservoir and decreases its volume to discharge lubrication oil when its respective transfer valve transfers lubrication oil to the lubrication points.

### DESCRIPTION OF THE DRAWINGS

FIG. 1 is a schematic diagram of a lubrication system according to a first possible embodiment of the invention.

FIG. 2 is a cut-away side view of a positive displacement metering capsule for the first possible embodiment of the invention.

FIG. 3 is a schematic diagram of a lubrication system according to a second possible embodiment of the invention.

FIG. 4 is a cut-away side view of a positive displacement metering capsule for the second possible embodiment of the invention.

FIG. 5 is a lubrication system according to a third possible embodiment of the invention.

FIG. 6 is a cut-away side view of a positive displacement metering capsule for the third possible embodiment of the invention.

### DETAILED DESCRIPTION OF THE INVENTION

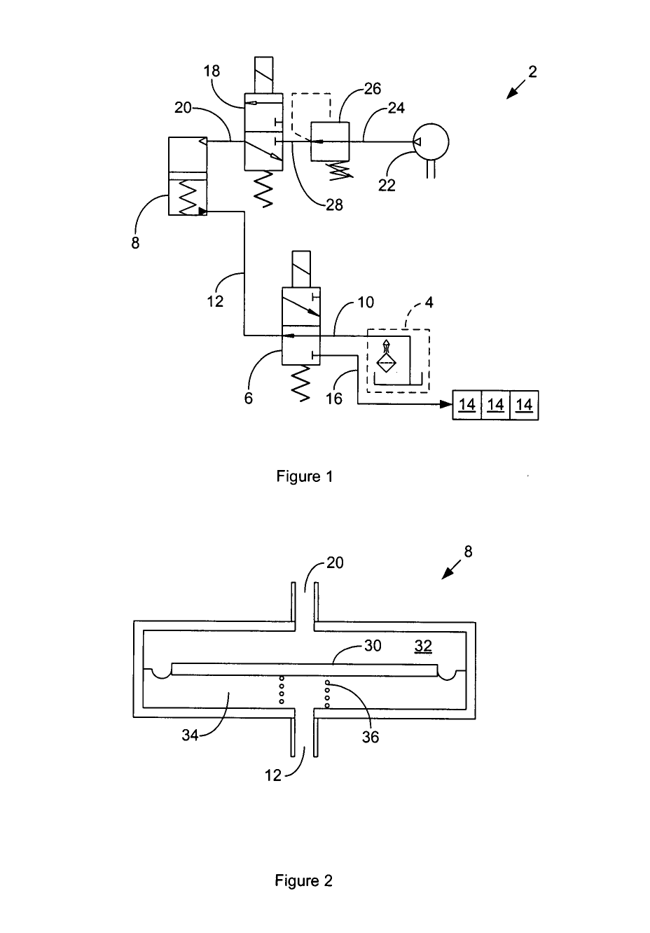

FIG. 1 is a schematic diagram of a lubrication system 2 according to a first possible embodiment of the invention. The lubrication system 2 comprises a lubrication oil tank 4 for storing a quantity of lubrication oil. A lubrication oil transfer valve 6 couples the lubrication oil tank 4 to one side of a positive displacement metering capsule 8 when the lubrication oil transfer valve 6 is in a first state by way of a tank line 10 and a transfer valve line 12. The lubrication oil transfer valve 6 couples the capsule 8 to lubrication points 14, such as engine bearings, when the lubrication oil transfer valve 6 is in a second state by way of the transfer valve line 12 and a lubrication line 16.

The lubrication oil transfer valve 6 may be a three-way valve as shown in FIG. 1, with the lubrication oil tank 4 coupled to the actuator 8 when the lubrication oil transfer valve 6 is in a de-energized state and with the lubrication points 14 coupled to the capsule 8 when the lubrication oil transfer valve is in an energized state. The lubrication oil transfer valve 6 may comprise an electrically operated valve, such as a solenoid-operated valve as shown in FIG. 1, or a piezoelectric element-operated valve. It may also comprise a mechanically, pneumatically or hydraulically operated valve.

The capsule 8 may comprise a hydraulic-pneumatic capsule or actuator, and it may be of the piston, bellows or diaphragm type. The displacement of the capsule 8 comprises a difference in volume between a maximum volume when it fills with lubrication oil and a minimum volume when it has discharged lubrication oil. FIG. 2 is a cut-away side view of the hydraulic capsule 8 of with a movable partition of the diaphragm type. Referring to FIGS. 1 and 2 together, a gas supply valve 18 couples to the other side of the capsule 8 by means of a gas valve line 20. When the gas supply valve 18 is in a first state, it couples the capsule 8 to ambient atmosphere. When the gas supply valve 18 is in a second state, it couples the capsule 8 to an gas source 22, typically by way of an gas source line 24, a pressure regulating valve (PRV) 26 and a PRV line 28, although if the gas source 22 has a sufficiently stable pressure, the gas source line 24 may couple directly to the gas supply valve 18. The gas source 22 is typically an engine air compressor as shown in FIG. 1, although it may alternatively be another type of gas source, such as a compressed gas reservoir. In any case, the working gas may be air or any other convenient working gas and references to gas herein refers to air and any other working gas.

The gas supply valve 18 may be a three-way valve as shown in FIG. 1, with the vessel 8 coupled to ambient atmosphere when the gas supply valve 18 is in a de-energized state and with the vessel 8 coupled to the gas source 20 when the gas supply valve 18 is in a de-energized state. The gas supply valve 18 may comprise a solenoid-operated valve as shown in FIG. 1, or it may comprise a mechanically, pneumatically or hydraulically operated valve.

The vessel 8 has a moveable partition 30 mounted within a cavity 32. The partition 30 may comprise an elastomeric suspension-supported diaphragm as shown in FIG. 2 or a pre-tensioned metallic diaphragm. Alternatively, the partition 30 may comprise a piston or bellows. A portion of the cavity 32 between the partition 30 and the lubrication line 16 forms a lubrication oil chamber 34 that has a changeable volume. A bias spring 36 within the lubrication oil chamber 34 applies force against the partition 30 to push it toward a side of the cavity 32 with the gas valve line 20. When the lubrication oil transfer valve 6 switches to its first or de-energized state, it allows lubrication oil to flow from the lubrication oil reservoir 4 into the capsule 8 by means of the transfer valve line 12. As the gas supply valve 18 switches to its first or de-energized state, gas within the capsule cavity 32 adjacent the gas valve line 20 exhausts to atmosphere by means of the gas valve line 20. The bias spring 36 is then able to force the partition 30 against the side of the cavity 32 with the gas valve line 20 and increase the volume of the lubrication oil chamber 34. As the lubrication oil chamber 34 increases volume, it sucks in lubrication oil by means of the transfer valve line 12.

When the lubrication oil transfer valve 6 switches to its second or energized state, it allows lubrication oil in the lubrication oil chamber 34 of the capsule 8 to flow to the lubrication points 14 by way of the transfer valve line 12 and the lubrication line 16. As the gas supply valve 18 switches to its second or energized state, it allows compressed gas from the gas source 22 to flow to the capsule 8 by way of the gas valve line 20 and the gas source line 24 to let the diaphragm 30 overcome the force of the bias spring 36 and move against the side of the cavity 32 with the transfer valve line 12, thereby driving the lubrication oil in the lubrication oil chamber 34 to the lubrication points 14. Since the change in volume of the lubrication oil chamber 34 is a fixed quantity, the lubrication system 2 can time-sequence the first and second states of the lubrication oil transfer valve 6 and the gas supply valve 18 to sequentially transfer discrete defined quantities of lubrication oil to the lubrication points 14 at timed intervals.

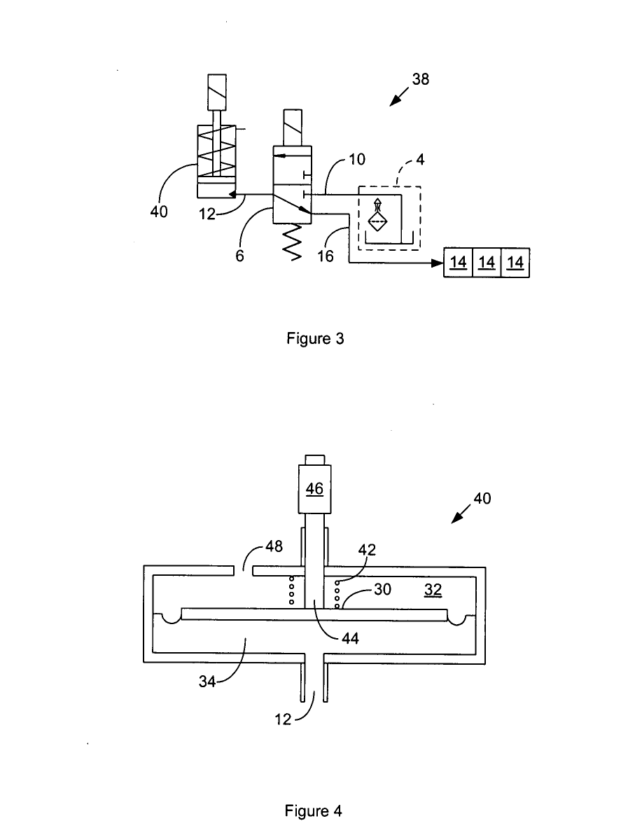

FIG. 3 is a schematic diagram of a lubrication system 38 according to a second possible embodiment of the invention. It has an advantage over the hereinbefore-described lubrication system 2 that comprises fewer components and no need for the gas source 22. The lubrication system 38 substitutes a positive displacement metering capsule 40 for the capsule 8. The capsule 40 may comprise a hydraulic actuator, and it may be of the piston, bellows or diaphragm type. FIG. 4 is a cut-away side view of the capsule 40 of the diaphragm type. Referring to FIGS. 3 and 4 together, the capsule 40 has the partition 30 mounted within the cavity 32, much the same as for the capsule 8. The partition 30 may comprise an elastomeric suspension-supported diaphragm as shown in FIG. 4 or a pre-tensioned metallic diaphragm. Alternatively, the partition 30 may comprise a piston or bellows. A portion of the cavity 32 between the partition 30 and the transfer valve line 12 forms the lubrication oil chamber 34 that has a changeable volume.

A bias spring 42 applies force against the partition 30 to push it toward a side of the cavity 32 with the transfer valve line 12. A ferrous rod or armature 44 attached to the opposite side of the partition 30 extends out of the cavity 32 into a solenoid 46. Energizing the solenoid 46 may apply force to the armature 44 to overcome the bias force of the bias spring 42 to pull the armature 44 out of the cavity 32 from a first relaxed state to a second extended state. A vent 48 through the side of the cavity 32 with the armature 44 exhausts to ambient atmosphere.

When the lubrication oil transfer valve 6 switches to its second or energized state, it allows lubrication oil to flow from the lubrication oil reservoir 4 to the capsule 40 by means of the transfer valve line 12. When the armature 44 switches to its second or extended state, such as by energizing the solenoid 46, it pulls the partition 30 with it, thereby increasing the volume of the lubrication oil chamber 34. As the lubrication oil chamber 34 increases in volume, it sucks in lubrication oil by means of the transfer valve line 12. When the lubrication oil transfer valve 6 switches to its first or de-energized state, it allows lubrication oil in the lubrication oil chamber 34 to flow to the lubrication points 14 by way of the transfer valve line 12 and the lubrication line 16. As the armature 44 switches to its first or relaxed state, such as by de-energizing the solenoid 46, it allows the bias spring 42 to force the partition 30 toward the side of the cavity 32 with the transfer valve line 12, thereby decreasing its volume and driving the lubrication oil in the cavity lubrication oil chamber 34 to the lubrication points 14.

FIG. 5 is a schematic diagram of a lubrication system 50 according to a third possible embodiment of the invention. It has an advantage over the hereinbefore-described lubrication systems 2 and 38 that comprises less power consumption and positive lubrication oil feed. The lubrication system 50 substitutes a pressurized lubrication oil tank 52 for the lubrication oil tank 4. The lubrication oil tank 52 may comprise a gas-pressurized bladder-type accumulator and may have a gas pre-charge or alternatively it may have pressure supplied by way of the gas source 22, typically by way of an gas source line 24, a pressure regulating valve (PRV) 26 if the gas source 22 is not sufficiently stable and a PRV line 28 as hereinbefore described in connection with FIG. 1.

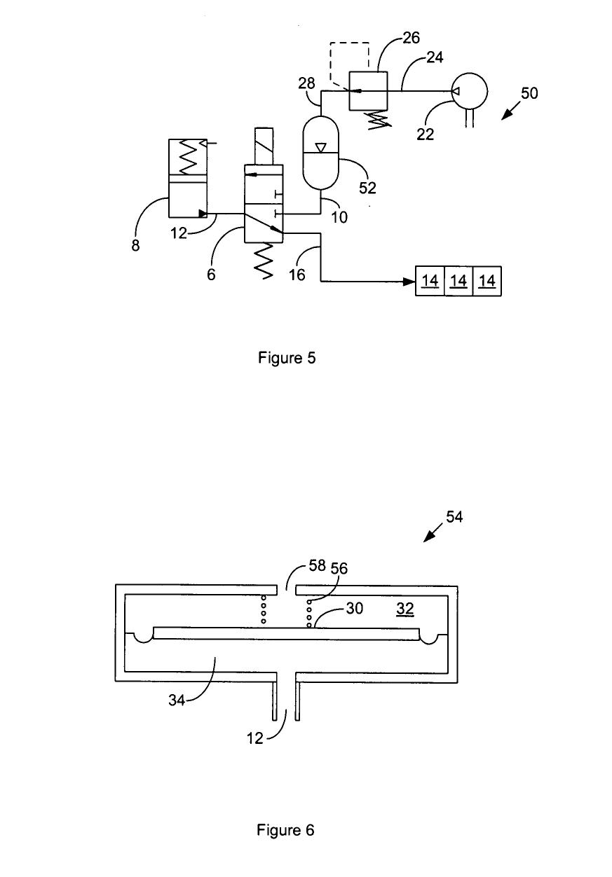

The lubrication system 50 also substitutes a positive displacement metering capsule 54 for the hereinbefore-described capsules 8 and 40. The capsule 54 may comprise a hydraulic-pneumatic capsule or actuator, and it may be of the piston, bellows or diaphragm type. FIG. 6 is a cut-away side view of the capsule 54 of the diaphragm type. Referring to FIGS. 5 and 6 together, the capsule 54 has the partition 30 mounted within the cavity 32, much the same as for the capsules 8 and 40. The partition 30 may comprise an elastomeric suspension-supported diaphragm as shown in FIG. 4 or a pre-tensioned metallic diaphragm. Alternatively, the partition 30 may comprise a piston or bellows. A portion of the cavity 32 between the partition 30 and the transfer valve line 16 forms the lubrication oil chamber 34 that has a changeable volume.

A bias spring 56 applies force against the partition 30 to push it toward a side of the cavity 32 with the transfer valve line 12. A vent 58 through the side of the cavity 32 with the bias spring 56 exhaust to ambient atmosphere. When the lubrication oil transfer valve 6 switches to its second or energized state, it allows lubrication oil to flow from the lubrication oil reservoir 52 to the capsule 54 by means of the transfer valve line 12. The pressure of the lubrication oil flowing into the lubrication oil chamber 34 overcomes the force of the bias spring 56 to fill the lubrication oil chamber 34 with lubrication oil.

When the lubrication oil transfer valve 6 switches to its first or de-energized state, it allows lubrication oil in the lubrication oil chamber 34 to flow to the lubrication points 14 by way of the transfer valve line 12 and the lubrication line 16. The force of the bias spring 56 the partition 30 toward the side of the cavity 32 with the transfer valve line 12, thereby decreasing its volume and driving the lubrication oil in the cavity lubrication oil chamber 34 to the lubrication points 14.

Although the lubrication systems 2, 38 and 50 as hereinbefore described utilize a single respective capsule 8, 40 and 50 to transfer lubrication oil to lubrication points 14, alternatively the lubrication systems 2, 38 and 50 may have multiple capsules 8, 40 and 54, each supplying lubrication oil to a different respective lubrication point 14.

The described embodiments of the invention are only some illustrative implementations of the invention wherein changes and substitutions of the various parts and arrangement thereof are within the scope of the invention as set forth in the attached claims.

1. A lubrication system for transferring sequential defined quantities of lubrication oil to lubrication points, comprising:
a lubrication oil reservoir for storing the lubrication oil;
at least one positive displacement metering capsule; and
a transfer valve for each capsule that alternately transfers lubrication oil from the lubrication oil reservoir to its respective capsule and from its respective capsule to its respective lubrication points;
wherein each capsule increases its volume to receive the lubrication oil when its respective transfer valve transfers lubrication oil from the lubrication oil reservoir and decreases its volume to discharge lubrication oil when its respective transfer valve transfers lubrication oil to its respective lubrication points.

2. The lubrication system of claim 1, wherein each transfer valve comprises a three-way valve.

3. The lubrication system of claim 1, wherein each transfer valve is a solenoid-operated valve.

4. The lubrication system of claim 1, further comprising a gas source, wherein pressurized gas from the gas source changes the volume of each capsule.

5. The lubrication system of claim 4, further comprising a gas supply valve, wherein the gas supply valve controls the application of pressurized gas to each capsule.

6. The lubrication system of claim 5, wherein the gas supply valve is a three-way valve.

7. The lubrication system of claim 5, wherein the gas supply valve is a solenoid-operated valve.

8. The lubrication system of claim 1, wherein an armature controls the displacement of each capsule.

9. The lubrication system of claim 8, wherein a solenoid operates the armature for each respective capsule.

10. The lubrication system of claim 1, wherein each capsule is a hydraulic actuator with a spring-biased partition.

11. A lubrication system for transferring sequential defined quantities of lubrication oil to lubrication points, comprising:
a lubrication oil reservoir for storing the lubrication oil;
at least one positive displacement metering capsule with a volume controllable by pressurized gas;
a gas source for generating pressurized gas;
a gas supply valve for controlling the application of pressurized gas to each capsule and
a transfer valve for each capsule that alternately transfers lubrication oil from the lubrication oil reservoir to its respective capsule and from its respective capsule to its respective lubrication points;
wherein the gas supply valve applies pressurized gas to each capsule to increase its volume to intake the lubrication oil when its respective transfer valve transfers lubrication oil from the lubrication oil reservoir and the gas supply valve removes pressurized gas each capsule to decrease its volume to discharge lubrication oil when its respective transfer valve transfers lubrication oil to its respective lubrication points.

12. The lubrication system of claim 11, wherein each transfer valve comprises a three-way valve.

13. The lubrication system of claim 11, wherein each transfer valve is a solenoid-operated valve.

14. The lubrication system of claim 11, wherein the gas supply valve is a three-way valve.

15. The lubrication system of claim 11, wherein the gas supply valve is a solenoid-operated valve.

16. The lubrication system of claim 11, wherein the capsule is a hydraulic-pneumatic actuator with a spring-biased partition.

17. A lubrication system for transferring sequential defined quantities of lubrication oil to lubrication points, comprising:
a lubrication oil reservoir for storing the lubrication oil;
at least one positive displacement metering capsule with a volume controllable by an armature;
a solenoid for each capsule that controls the position of the armature; and
a transfer valve for each capsule that alternately transfers lubrication oil from the lubrication oil reservoir to its respective capsule and from its respective capsule to its respective lubrication points;
wherein each solenoid extends the armature for its respective capsule to increase volume of the its respective capsule to receive the lubrication oil when its respective transfer valve transfers lubrication oil from the lubrication oil reservoir and each solenoid releases the armature for its respective capsule to decrease volume of its respective capsule to discharge lubrication oil when its respective transfer valve transfers lubrication oil to its respective lubrication points

18. The lubrication system of claim 17, wherein each transfer valve comprises a three-way valve.

19. The lubrication system of claim 17, wherein each transfer valve is a solenoid-operated valve.

20. The lubrication system of claim 17, wherein each actuator has a spring-biased partition and the armature attaches to the partition.

21. A lubrication system for transferring sequential defined quantities of lubrication oil to lubrication points, comprising:
a pressurized lubrication oil reservoir for storing the lubrication oil;
at least one positive displacement metering capsule with a volume controllable by lubrication oil pressure; and
at least one transfer valve for each capsule that alternately transfers lubrication oil from the lubrication oil reservoir to its respective capsule and from its respective capsule to the lubrication points;
wherein each capsule increases its volume to receive the lubrication oil when its respective transfer valve transfers lubrication oil from the lubrication oil reservoir and decreases its volume to discharge lubrication oil when its respective transfer valve transfers lubrication oil to the lubrication points.

22. The lubrication system of claim 21, wherein each transfer valve comprises a three-way valve.

23. The lubrication system of claim 21, wherein each transfer valve is a solenoid-operated valve.

24. The lubrication system of claim 21, wherein each capsule has a spring-biased partition.

25. A method of transferring sequential defined quantities of lubrication oil from a lubrication oil reservoir to lubrication points by means of at least one positive displacement metering capsule, comprising the steps of:
minimizing the volume of the each capsule;
coupling each capsule to the lubrication oil reservoir;
maximizing the volume of each capsule to suck lubrication oil from the lubrication oil reservoir into the capsule;
coupling each capsule to respective lubrication points; and
minimizing the displacement of each capsule to discharge lubrication oil from each capsule to its respective lubrication points.
